(19) United States
(12) Patent Application Publication
(10) Pub. No.: US 2007/0297169 A1
(43) Pub. Date: Dec. 27, 2007

(54) Lighting Device

(75) Inventor: Robert Douglas Holmes, Devon (GB)

Correspondence Address: CONNOLLY BOVE LODGE & HUTZ, LLP, P O BOX 2207, WILMINGTON, DE, 19899, US

(73) Assignee: GRO-GROUP INTERNATIONAL LIMITED, Devon (GB)

(21) Appl. No.: 11/768,294

(22) Filed: Jun. 26, 2007

(30) Foreign Application Priority Data
Jun. 27, 2006 (GB) 0612663.5

(51) Int. Cl. B60Q 1/26

(52) U.S. Cl. 362/227; 362/147; 362/276

(57) ABSTRACT

A lighting device, useable for example as a nightlight, comprises (a) first connection means for connection to an existing (“primary”) light fitting, (b) second connection means for connection to a primary light source, (c) an integrated secondary light source and (d) electrical and/or electronic controls arranged such that both the integrated secondary light source and a primary light source connected to the device via the second connection means can be operated using an existing primary switch associated with the primary light fitting. The device may include a light sensor, allowing its operation to depend on ambient light levels.

### FIELD OF THE INVENTION

This invention relates to a lighting device, in particular for use as a nightlight.

### BACKGROUND TO THE INVENTION

Known nightlight devices are used to provide a relatively low level of light, in areas such as landings, stairwells and corridors, either during the hours of darkness or when the area is inherently poorly lit.

Conventionally, such devices are designed to be plugged into a wall-mounted electrical socket. They often use relatively low power light sources such as light emitting diodes (LEDs).

Nightlights are also often used in nurseries and children's bedrooms, to alleviate fears of the dark and/or to assist children in navigating their way around the room if they need to get up during the night.

Nightlights and other low level lighting devices may also be used when carers need to go to children's rooms during the night, for instance to feed or change them or simply to check on them, the main room light being typically too bright for this purpose and likely to wake the children unnecessarily. Unless such a nightlight is left on throughout the night, which of course can be wasteful of power, the carer often has difficulty in locating or reaching its controls in the initially dark room, and in finding the way out of the room, in the dark, once the nightlight has been switched off. Moreover such nightlights typically provide only very low power, and highly localised, illumination, and when connected to wall-mounted electrical sockets they are typically positioned at or near to floor level. They therefore provide inadequate, and inappropriately positioned, illumination for performing tasks such as nappy changing, bottle warming or bed making.

The fact that nightlights are usually plugged into wall sockets also makes them unsuitable for illuminating stairwells, where there are not typically any electrical sockets, yet stairwells can be extremely dangerous for young children—and indeed for adults too—in the dark.

It is an aim of the present invention to provide a lighting device, in particular for use as a nightlight and more particularly for use in children's bedrooms and nurseries, which can overcome or at least mitigate the above described problems.

### STATEMENTS OF THE INVENTION

According to a first aspect of the present invention there is provided a lighting device comprising (a) first connection means for connecting the device to an existing (“primary”) electrical light fitting, (b) second connection means for connecting the device to a primary light source, (c) an integrated secondary light source and (d) electrical and/or electronic controls arranged such that both the integrated secondary light source and a primary light source connected to the device via the second connection means can be operated using an existing switch associated with the primary light fitting.

A lighting device in accordance with the invention may thus be connected between an existing light fitting and a primary light source such as a bulb, providing an electrical connection between the two, and can thereby provide control over operation of both the primary light source and the integrated secondary light source.

Because the device can be connected to an existing light fitting, it may be retrofitted with relative ease to for example a wall- or ceiling-mounted light fitting, or to a lamp such as a bedside lamp, table lamp or standard lamp. In use, it is positioned within an existing (“primary”) electrical lighting circuit, between the usual primary light source (typically a bulb) and an associated switch provided in the primary lighting circuit. However no re-wiring of, or other modification to, the existing lighting circuit is needed in order to install the device in this way.

The device can therefore be used to provide a nightlight type of illumination—ie, relatively low powered—in more appropriate locations than has previously been possible. For example, it may be connected to wall- or ceiling-mounted light fittings provided in a stairwell or other region which lacks wall-mounted electrical sockets.

The first connection means, which effectively allows the device to be connected into an existing (primary) lighting circuit may have the same or essentially the same form as the connecting part of a light source—such as a bulb—intended for use with the existing light fitting. It may for instance be a male connector such as a bayonet or screw connector.

The second connection means of the device may be adapted for connection to a light source, such as a bulb, intended for use with the existing light fitting. It may therefore have the same or essentially the same form as the light source receiving section of the existing light fitting. It may for instance be a female connector such as a socket in particular a socket adapted to receive a bayonet or screw type male connector on a conventional filament light bulb.

Suitably the second connection means is adapted for connection to a (typically annular) collar, of the type which is conventionally provided as part of a light fitting in order to attach a light shade to the fitting. The second connection means may for example have a (typically annular) screw threaded portion, or other means adapted to interengage with elements provided on an existing collar. In this way, the device of the invention may be connected to an existing light fitting, and a light shade and supporting collar then mounted on the device in the same way as they would conventionally have been mounted on the existing light fitting.

The primary lighting circuit to which the device of the invention can be connected may be, or be connected to, a mains circuit. The existing light fitting may for example be, as described above, a wall- or ceiling-mounted mains light fitting, in particular a ceiling-mounted fitting such as a pendant light fitting. It may alternatively be a lamp fitting such as on a table lamp or standard lamp.

The primary light source to which the device is connectable may be a light bulb, in particular a filament bulb. It may be a low energy light bulb.

The secondary light source, which is integrated into the lighting device of the invention, may have a relatively low power output. It may for example be a small bulb. In particular it may be a light emitting diode (LED).

The device may include more than one secondary light source. These may for example be radially spaced around its periphery. In one embodiment, the device has two secondary light sources, which may be positioned diametrically opposite one another. In another embodiment, the device has three or four secondary light sources, for example two pairs of two secondary light sources positioned diametrically opposite one another.

Where the device is intended for connection to a ceiling-hung light fitting, the secondary light source(s) may be positioned on or close to what will in use be its upper face, ie, the face which carries the first connection means. Thus, in use, the secondary light source(s) may face upwardly. Instead or in addition they may face radially outwards. This can allow the emitted light to be reflected downwards off the ceiling, thus providing a broader and often more pleasing form of illumination.

The secondary light source, the controls of the device and any associated user-operable controls may all be housed within a single unit, for example within a casing made of a (suitably heat resistant) plastics material.

A lighting device according to the invention may be relatively small in size. It may for instance be of a size and shape suitable to allow its connection to an existing light bulb and light fitting, whilst still allowing a conventional light or lamp shade to be mounted on the light fitting. The device may therefore be unobtrusively installed where needed.

The device may for example have a circular, or approximately circular, cross section. It may take the form of a flattened sphere or ellipsoid (eg, a “doughnut”-like shape).

The device may have means which in use are capable of receiving the arms of a light shade mounted on the existing light fitting. Such receiving means may comprise one or more recessed portions, conveniently provided in that surface of the device which carries the second connection means. There may be two or more, such as either two or four, such receiving means. They may take the form of radially directed grooves.

When the device is connected into an existing primary lighting circuit, it must allow an electrical connection, via its own controls, between the primary light source and a switch associated with (ie, electrically connected to—whether directly or indirectly, and whether via wired or wireless connections) the existing light fitting. The controls of the device must allow for both the primary and the secondary light sources to be operated, at least partially, using this existing (“primary”) light switch. The primary switch may be a wall-mounted switch useable to operate an existing mains-wired wall- or ceiling-mounted light fitting, or a switch provided on, or associated with, an existing lamp unit (the switch may for example be positioned at a point where a lamp is plugged into the mains electrical supply). The primary switch may be remotely controllable.

The controls of the device should be arranged to receive, and respond to, signals received from the existing primary switch. In this way, operations performed at the existing switch may be used to control operation of both the primary and the secondary light sources. The controls may be arranged to respond to one or more predetermined switching sequences (for example, on and immediately off again, or a more complex pattern such as on-off-on).

Suitably the controls are arranged to allow the device to operate in two or more distinct modes, and for a user to select the desired mode via the existing light switch. Each mode may provide a different combination of light from the two sources, for example both light sources on, both off or only one of them on.

In one embodiment of the invention, the lighting device includes a light sensor—for example a photo-electric cell—which is capable of detecting the ambient light level and of signaling accordingly to the controls of the device. This sensor may be integrated into, provided on or otherwise associated with the device. Signals from the light sensor may be used to influence whether and/or when either or both of the primary and secondary light sources is on. The light sensor may have a user-variable sensitivity, so as to allow a user to select for example whether either or both of the light sources should be on only in the pitch dark or also in cases where there is a low level of ambient light (for example, from a nearby street lamp).

The controls of the device may therefore include an electrical and/or electronic circuit which, in use, is electrically connected to both the existing primary light switch and the primary light source, which circuit also incorporates the light sensor. This circuit may be arranged such that when the sensor detects an ambient light level (in the region in which the device is being used) below a threshold level which can be selected by a user of the device, operation of the primary switch causes the integrated secondary light source of the device to illuminate, whereas if the sensor detects an ambient light level above said threshold, operation of the primary switch activates the primary light source. Thus, such controls respond to operation of the primary light switch, but their response is also influenced by signals received from the light sensor which in turn depend on the level of ambient light in the region.

Suitably the controls of the device are integrated into it, for example within a casing, to protect them and to reduce the risk of tampering.

Additional user-operable controls may be provided on the device. Such controls may include means for varying the sensitivity of a light sensor included in or associated with the device. They may include means for varying the power output of the primary and/or secondary light sources, in particular the secondary light source.

According to a second aspect the present invention provides a lighting assembly comprising a lighting device in accordance with the first aspect, and a primary light fitting such as a wall- or ceiling-mountable mains-connectable light fitting or a lamp. The lighting device may be connected to, or even integrated with, the primary light fitting. Alternatively the two may be provided together, for connection prior to use.

A third aspect of the invention provides a lighting device in accordance with the first aspect, or a lighting assembly according to the second, in combination with a primary light source such as a bulb.

A fourth aspect of the invention provides a method of providing illumination in a region, such as a room, which is provided with an existing primary light fitting (for example a wall- or ceiling-mounted light fining, or a lamp) and an associated primary switch, the method involving installing in the region a lighting device according to the first aspect of the invention, in electrical communication with both the primary light fitting and the primary switch, such that both the lighting device of the invention and the primary light fitting are controllable using the primary switch. The primary switch may be wall-mounted, or provided on or associated with the primary light fitting; suitably it is wall-mounted. The electrical circuit connecting the lighting device of the invention, the primary light fitting and the primary switch is suitably such that when the ambient light in the region is below a threshold level which can be selected by a user of the lighting device, activation of the primary switch causes the integrated secondary light source of the device to illuminate, whereas if the ambient light is above said threshold, activation of the primary switch causes illumination of a primary light source connected to the primary light fitting via the device of the invention. The circuit may also be such that operation of the primary switch in a particular way can activate the primary light source even when the ambient light in the region is below the selected threshold level.

The method of the fourth aspect of the invention may be used to adapt the lighting already provided in a region. It may additionally involve the step of selecting a desired threshold ambient light level on the controls of the lighting device.

A fifth aspect of the invention provides an electrical lighting circuit which includes a primary light fitting, a primary light switch and a device according to the invention, connected together in the manner described above.

According to a sixth aspect, the invention provides a method of illuminating a region, such as a room, which region may be provided with an electrical lighting circuit according to the fifth aspect, the method involving entering or approaching the region at a time when the ambient light is below a threshold level which can be or has been selected on a lighting device according to the invention, switching on an existing primary light switch, and thereby causing the secondary light source of the device of the invention to illuminate instead of a primary light source to which the device is connected. This method can thus result in a relatively low powered, usually softer, level of illumination (ie, a nightlight type of illumination) being provided in the region, which is more appropriate for the lower level of ambient light (typically indicating night time). The method may be used to illuminate a region without causing disturbance to, or with reduced disturbance to, an occupant of the region, for example a sleeping child.

The method of the sixth aspect may instead or in addition involve entering or approaching the region at a time when the ambient light is above the selected threshold level, switching on the primary light switch, and thereby causing activation of the primary light source instead of the secondary light source of the device of the invention.

Thus, this method in general terms involves entering or approaching the region, and utilising an existing primary light switch to achieve a type and/or level of illumination, for instance from an electrical lighting circuit according to the fifth aspect of the invention, which depends on the level of ambient light in the region.

The method may involve operating the primary light switch in such a way as to activate the primary light source even when the ambient light is below the selected threshold level. This may be done by operating the switch in a particular way, for example by turning it on and immediately off again during a predetermined time period as described above—the electrical lighting circuit including the circuitry provided in the device of the invention, may be arranged to respond to any suitable signal such as a predetermined sequence of switching operations.

In its broadest sense, the invention provides a method for illuminating a region, the method involving entering or approaching the region, and utilising an existing primary light switch to control both an existing, primary light source and a device capable of providing illumination from an integrated secondary light source, so as to achieve a type and/or level of illumination, from either or both of the primary and secondary sources, which depends on the level of ambient light in the region.

Throughout the description and claims of this specification, the words “comprise” and “contain” and variations of the words, for example “comprising” and “comprises”, mean “including but not limited to”, and do not exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Preferred features of each aspect of the invention may be as described in connection with any of the other aspects.

Other features of the present invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect embodiment or example described herein unless incompatible therewith.

Moreover unless stated otherwise, any feature disclosed herein may be replaced by an alternative feature serving the same or a similar purpose.

### DESCRIPTION OF THE DRAWINGS

The present invention will now be described by way of example only and with reference to the accompanying illustrative drawings, of which:

FIG. 1 is a perspective view from above of a lighting device in accordance with the invention;

FIG. 2 is an alternative perspective view of the FIG. 1 device, from below;

FIG. 3 is a side view of the FIG. 1 device, connected to a light bulb;

FIG. 4 shows a lighting assembly according to the invention, which includes a lighting device as shown in FIG. 1, connected to a ceiling-mounted light fitting;

FIG. 5 shows an alternative lighting assembly according to the invention, which includes a lighting device as shown in FIG. 1 connected to a lamp base;

FIG. 6 is a circuit diagram showing electrical and electronic controls suitable for use in the lighting device of FIG. 1;

FIGS. 7 and 8 are a perspective and an under plan view respectively of an alternative lighting device according to the invention;

FIGS. 9 and 10 are a perspective and an under plan view respectively of a further alternative lighting device according to the invention; and

FIG. 11 is a circuit diagram showing an electrical lighting circuit for a room which is provided with a lighting device according to the invention.

All figures are schematic.

### DETAILED DESCRIPTION

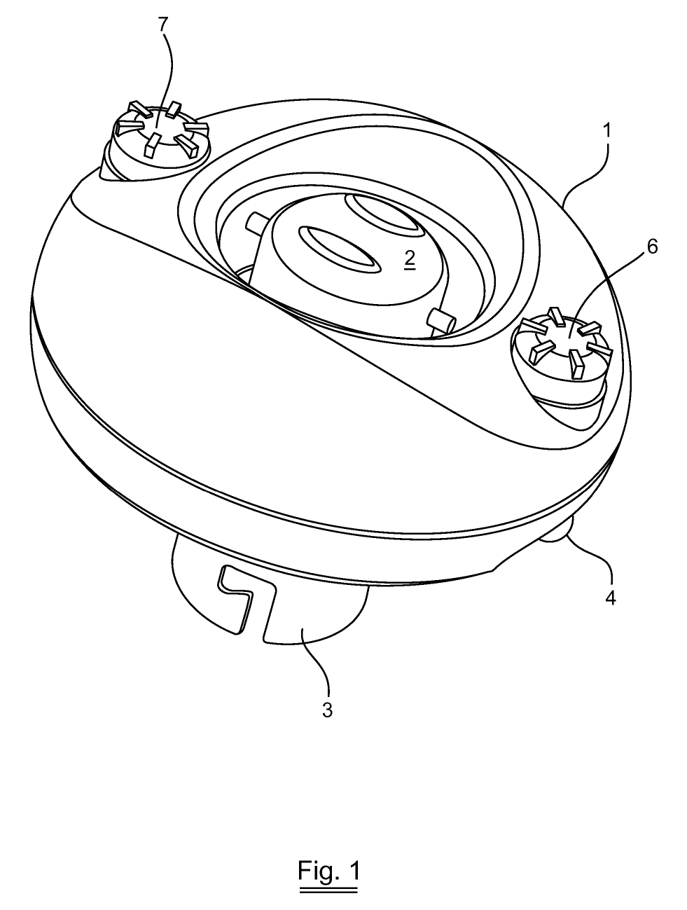

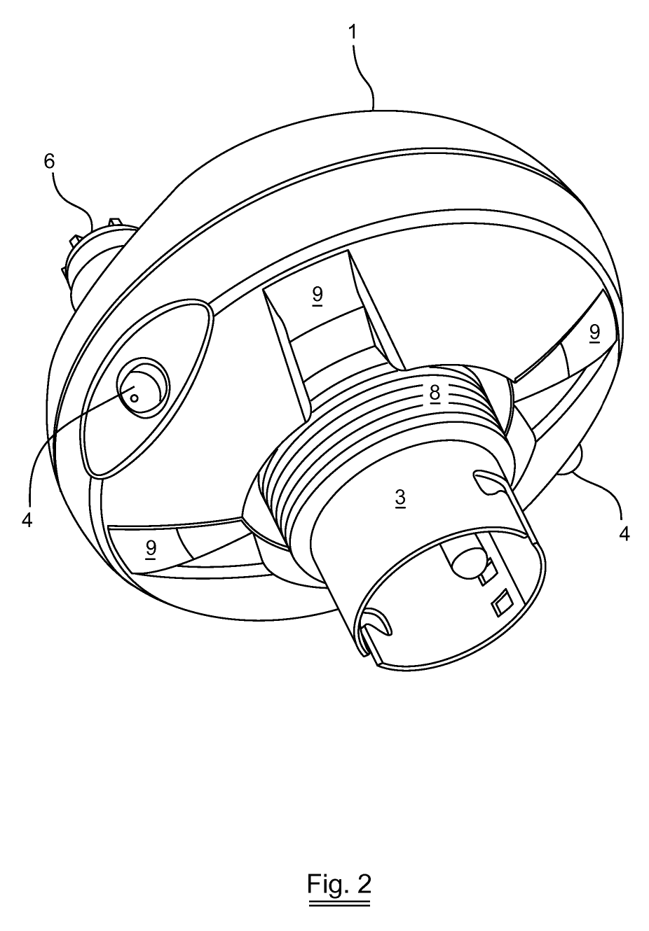

The lighting device shown in FIGS. 1 and 2 consists of a small doughnut-sized unit 1 encased in a heat resistant semi-translucent plastics material. The unit may for example be from 30 to 40 mm in diameter, such as about 35 mm, and from 45 to 65 mm, such as from 50 to 60 mm, in this case about 53 mm, in height. At one face it has a first connection means 2 in the form of a male bayonet connector, designed to connect to an existing light fitting such as a ceiling- or wall-mounted light socket or a tamp socket. At its opposite face it has a second connection means 3 in the form of a female bayonet socket, for receiving a standard bayonet-fixing bulb. Screw fittings may naturally be used instead of bayonet fittings for the first and second connection means.

The male connector 2 can be seen to be recessed into a surface of the device, which helps reduce the distance between an existing light fitting and a bulb or other primary light source connected to the device. In this case, for example, a light bulb connected via the device 1 need only be around 1.5 cm further from the existing light fitting than if connected to it directly without the device of the invention.

The device 1 has two integrated LED lamps 4 (see FIG. 2), positioned diametrically opposite one another. These function as “secondary” light sources, providing a relatively low power, soft and non-directional light useable as a nightlight. In the FIG. 1 device, the LEDs provide white light, but other colours may be used, as may a different number and/or position of secondary light sources.

Inside the casing of the device there are housed electrical and electronic controls (not shown), as will be explained in more detail below.

The device also has a light sensor (not shown), for example a photo-electric cell, which detects ambient light levels and signals accordingly to the controls. Since the casing is in this case semi-transparent, the light sensor may be located inside the device, for instance directly on a PCB forming part of its controls.

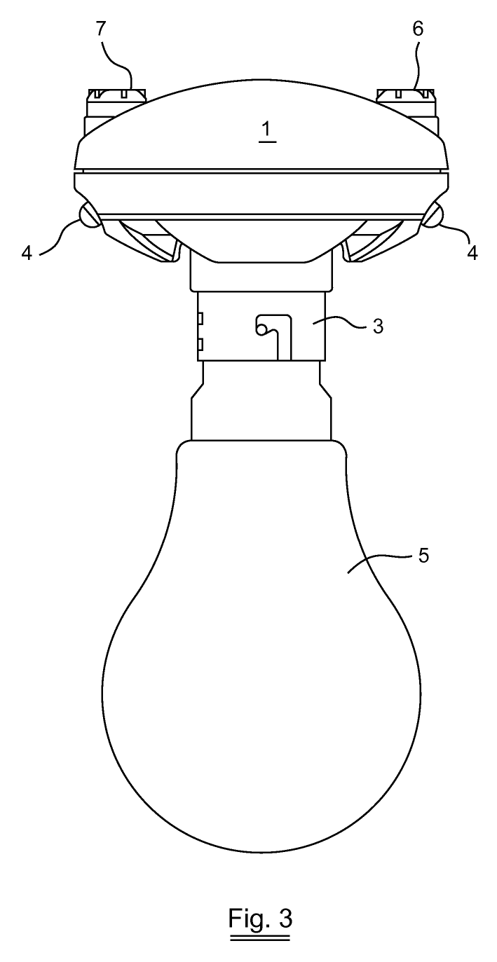

In FIG. 3, the device of FIGS. 1 and 2 is shown connected to a standard filament light bulb 5 via its second connection means 3. The device may also be connected, via its first connection means 2, to an existing light fitting such as a ceiling-mounted pendant light fitting.

The lighting device shown in FIGS. 1 to 3 has two user-operable controls. A first rotatable switch 6 allows a user to alter the sensitivity of the light sensor, and/or the way in which the device responds to signals from the light sensor, so as to adjust the threshold ambient light level at which operation of the nightlight LEDs is triggered. Thus for example the user may set the device to operate only if the surrounding area is completely dark, or alternatively to operate even if there are low levels of light present. The latter situation may be more appropriate where external light sources—for example, street lamps, neighbours' lights or even moonlight—increase the ambient light level.

A second rotatable switch 7 allows the user to alter the light output from the two LEDs 4.

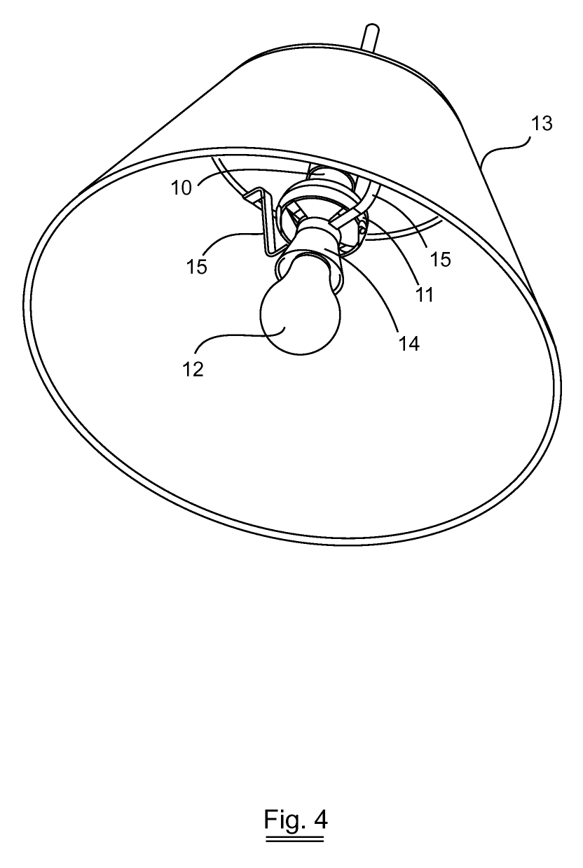

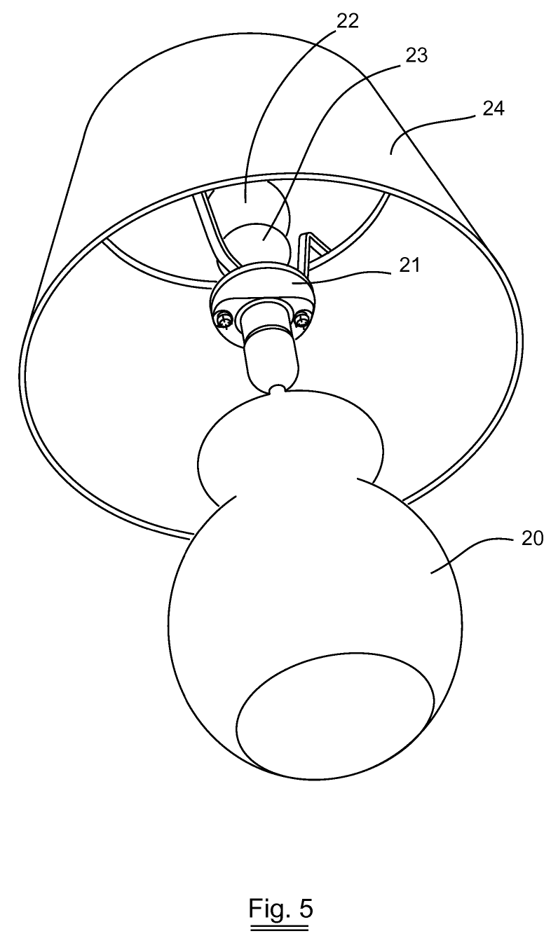

The female connecting portion 3 of the device suitably carries a screw thread around at least part of its outer surface, in this case around the annular portion 8 (see FIG. 2). This allows its connection to a collar associated with the existing light fitting, as described below in connection with FIGS. 4 and 5.

Four radial grooves 9 (see FIG. 2) are provided on the lower surface of the device, ie, that surface which carries the second connection means. These provide seatings for the arms of a light shade, again as explained in connection with FIGS. 4 and 5.

The device shown in FIGS. 1 to 3 may be used as follows. Firstly the device is connected to an existing light fitting, in this case a ceiling-hung pendant light fitting, via its first connection means 2. A standard filament light bulb such as 5 is then connected to the second connection means 3 of the device. The user selects the desired degree of sensitivity for the light sensor and the desired output level for the LED nightlights, using the dials 6 and 7. The assembly is now ready for use.

On entering the room or other area where the device is located, the user may switch on the device via the existing (typically wall-mounted) light switch which controls power to the existing light fitting. Such switches are usually positioned in readily accessible places, for example at arm height just inside the entrance to a room, and are therefore straightforward for the user to locate and operate.

When the device is switched on in this way, its light sensor detects the ambient light level and its controls then automatically switch on the LEDs if the light level is below the chosen threshold. Because these LEDs are high up in the room and because most ceilings are painted white, the light they provide is reflected downwardly off the ceiling and provides the user with wide, even illumination, without any working shadows. This type of lighting is more suitable for activities such as nappy changing, feeding and generally tending to a child than is the more localised, typically less appropriately positioned, light provided by more conventional nightlight units.

If the user prefers a higher level of lighting, the existing wall mounted light switch may be turned on and immediately off again during a five second time period, which signal causes the controls of the device to switch off the LEDs and instead to direct power to the higher output filament bulb. This effectively reverses the operational mode of the device, and may thus be used to “toggle” between LED and filament bulb illumination. In general a device according to the invention may be designed to respond to any appropriate form of signal from the existing light switch, not necessarily a simple on-off operation.

In order to return to the LED nightlight mode, the user must turn the existing light switch off and immediately back on in order to reset the controls of the device. The LEDs will then become operational again.

Alternatively, for example when a child goes to bed, the user may switch and leave the device on so that it will continue to provide a low level nightlight-type illumination during the desired period. Again the device may be switched on easily using an existing wall-mounted switch, for instance as the user leaves a child's room after having said goodnight.

The light sensor and the controls of the device may also be arranged so that during daylight but low light conditions (for example at dusk or dawn, on cloudy days or when the curtains are drawn during the day), switching the device on via the existing light switch automatically causes the main (filament) light bulb to operate, rather than the LED nightlights.

Thus the device of the invention may be entirely controlled from an existing light switch, and may be used to provide an appropriate balance at all times between the primary and secondary (LED) light sources. The controls of the device intelligently gauge, and deliver, the level of light that a user needs, all from a normal wall-mounted light switch. The advantages of being able to control the device from an existing switch are firstly that the user will already be familiar with the position of the switch; secondly that such switches tend to be conveniently positioned, for example just inside a room (thus allowing the user to operate the switch immediately before entering or leaving); and thirdly that most such switches are positioned out of the reach of small children (as is the device itself, for instance when connected to a ceiling-hung pendant light fitting), thus reducing the risk of tampering and improving the safety and security of the device.

Moreover a device according to the invention can be “retro-fitted” to an existing light fitting without the need for additional electrical wiring or for complex, time consuming and potentially costly installation. Once fitted, it can be unobtrusive, sitting easily underneath a conventional light shade. It need not interfere with the normal operation of the existing “primary” light source, but rather, can supplement or in cases replace that light source with a more appropriate form of illumination in low light conditions.

The device of FIGS. 1 to 3 may be used to provide constant low level illumination in dark areas or during the night, for instance in lobbies, corridors, landings and stairwells. This can be of value in ensuring the safety of those who may need to use the relevant area during the night, for instance in the event of a fire or if a child wakes and needs the bathroom or if a carer needs to visit a child. The device may be switchable to a mode in which the LEDs are permanently on, whatever the ambient light level, thus allowing the user to set the nightlight on before darkness falls. Additionally or alternatively it may be switchable to a mode in which the LEDs will turn on automatically once the ambient light falls below a selected threshold.

The controls of the device may comprise a timer and/or other programmable controls, to allow the user to set the device to operate at desired times of the day.

To achieve each mode of operation of the device (for example, (1) LEDs on but dependent on ambient light levels, (2) LEDs permanently on, regardless of light levels, (3) LEDs off but primary light on, (4) both LEDs and primary light on), its controls are designed to respond to predetermined signals from the existing light switch. Each such signal may be a particular pattern and/or timing of on-off operations, for instance as described above.

The device may also be provided with a back-up power supply, or at least a housing for a back-up power supply, for example a battery. It can then continue to provide low level nightlight-type illumination even in the event of a mains power cut.

A lighting device according to the invention may be used in areas such as bedrooms, in particular children's bedrooms and nurseries; in areas such as landings and bathrooms which may need to be visited during the night; in difficult to navigate areas such as corridors and stairwells; and generally in darker regions of a building such as those which have no natural daylight.

FIGS. 4 and 5 show lighting assemblies in accordance with the invention. That of FIG. 4 comprises a ceiling-hung pendant light fitting 10, of conventional type, to which has been connected a lighting device 11 according to the invention and a conventional filament light bulb 12. It can be seen that the device 11 fits unobtrusively underneath a conventional light shade 13. The annular collar 14, provided as part of the existing light fitting 10, screws into place around the second connection means of the device 11, below the supporting arms of the light shade, as is conventional. The light shade arms 15 fit neatly into the radial grooves provided on the lower surface of the device 11, and are then held in position by the collar 14.

The FIG. 4 assembly may be controlled, in the manner described above, via an existing wall-mounted light switch (not shown). No additional electrical circuitry is needed in order to achieve this; all the necessary controls are integrated into the device 11.

The FIG. 5 assembly comprises a conventional table lamp 20, again connected to a lighting device 21 according to the invention and a filament light bulb 22. The collar 23, provided as part of the lamp fitting, screws onto the second connection means of the device 21 and helps to hold the light shade 24 in position, the arms of the shade again being seated in the radial grooves provided on the device.

Operation of the bulb 22 and the LED nightlights of the device 21 is achieved via the existing lamp switch, which may be provided, in conventional fashion, either on the lamp stand or in the electrical flex by which the lamp is connected to the mains. Again no modification is needed to the existing lamp in order to operate it with the device of the invention.

In the assemblies of both FIG. 4 and FIG. 5, normal operation of the filament light bulb is still possible, but its light can be supplemented or replaced by the LED nightlights as and when desired.

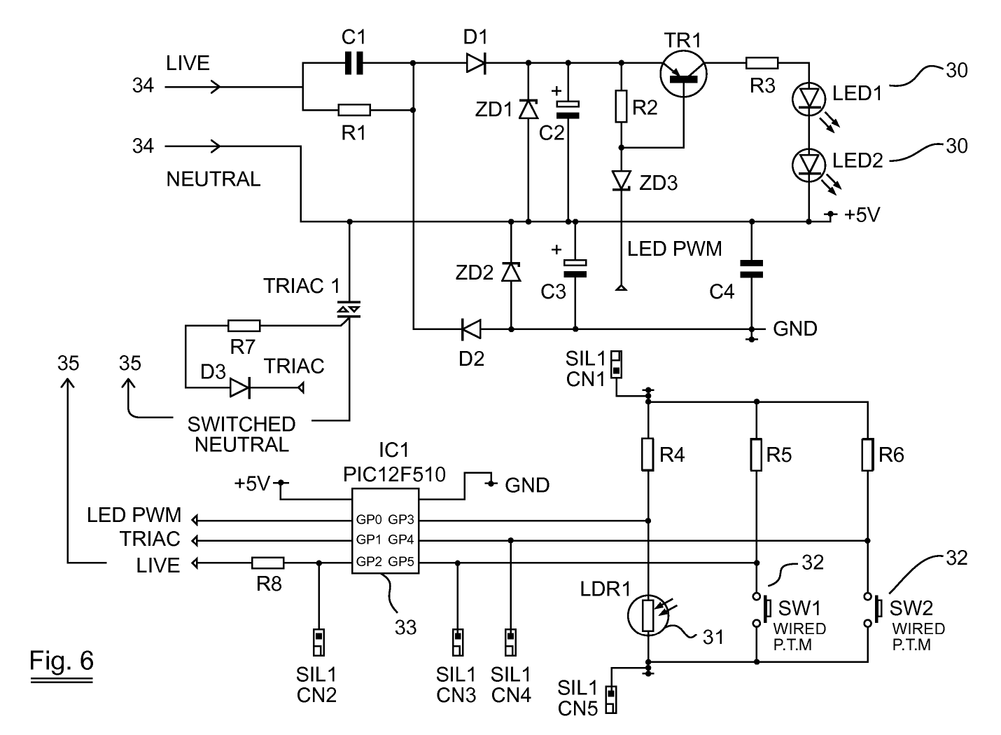

The circuit diagram in FIG. 6 shows controls which may be housed inside a device of the type shown in FIGS. 1 to 3. Items such as resistors, diodes, capacitors, transistors and the like are indicated in conventional fashion. The LED nightlights are shown at 30, the light sensor (here, a light dependent resistor) at 31 and the two user-operable switches of the unit at 32. Item 33 is an integrated circuit chip of type PIC12F510, which detects, and controls the unit's response to, both signals from the light sensor 31 and user-initiated on/off operations at the existing light switch. Items labeled CN allow connections to the chip for programming.

Also marked in FIG. 6 are the mains connection terminals 34 (power in) and 35 (power out), which are connected via the existing light fitting. The mains power supply is controlled by means of triacs as indicated.

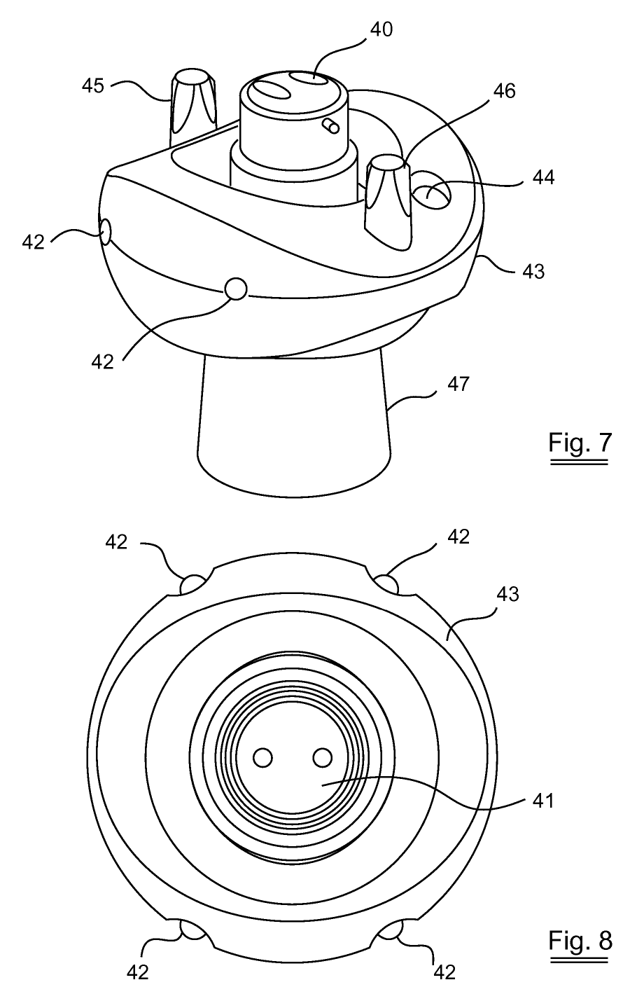

The lighting device of FIGS. 7 and 8 is similar in construction to those seen in FIGS. 1 to 5. On its upper surface it has a first connection means 40 in the form of a male bayonet connector, and on its underside (see FIG. 8) a second connection means 41 in the form of a female bayonet socket. Four LED lamps 42 are set into the casing 43 of the device, at intervals around its perimeter.

The device also has an ambient light sensor 44. Two user-operable controls 45 and 46 allow variation of the threshold light level below which operation of the LED lamps will be triggered, and also of the light output from the LEDs.

The second connection means is protected by a screw-on annular sheath or collar 47 (see FIG. 7). This can be removed in order to attach a lamp shade, and screwed back into position to hold the shade in place between itself and the main body of the device. The sheath 47 can therefore function in the same way as the screw-on collar which is conventionally associated with a light fitting.

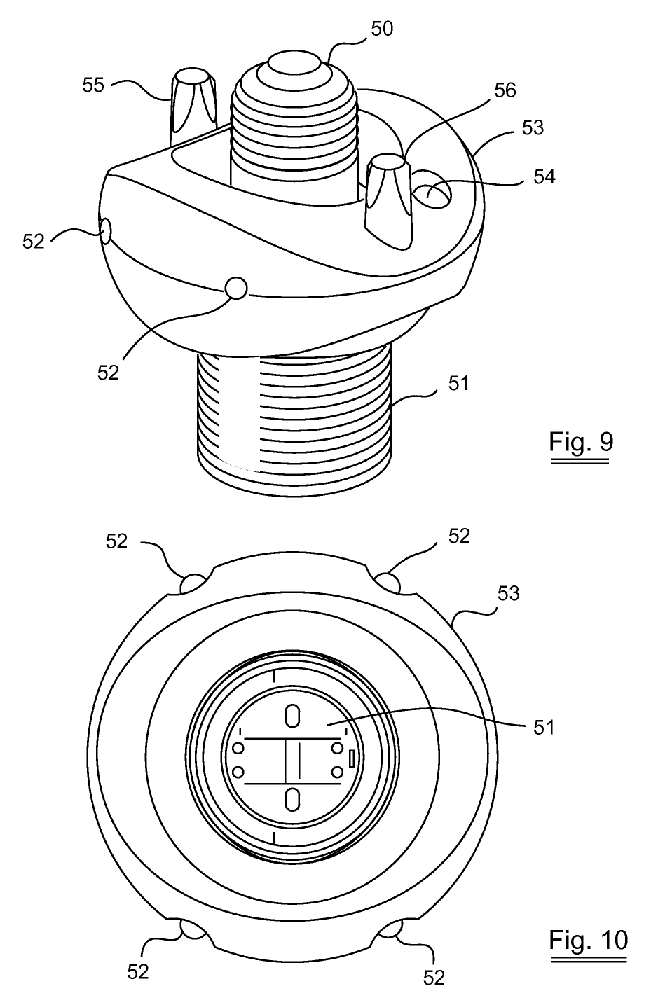

The device of FIGS. 9 and 10 is analogous to that of FIGS. 7 and 8, but is adapted for connection to a screw-type light fitting (for instance, an Edison screw fitting). Its first connection means 50 is in the form of a male screw connector, and its second connection means 51 an internally threaded socket. The female connecting portion 51 carries a screw thread around its outer surface, to allow its connection to a collar associated with an existing light fitting, for example as described above in connection with FIGS. 4 and 5. Again the FIGS. 9 and 10 device has four LED lamps 52 around the perimeter of its casing 53; an ambient light sensor 54; and two user-operable control knobs 55 and 56.

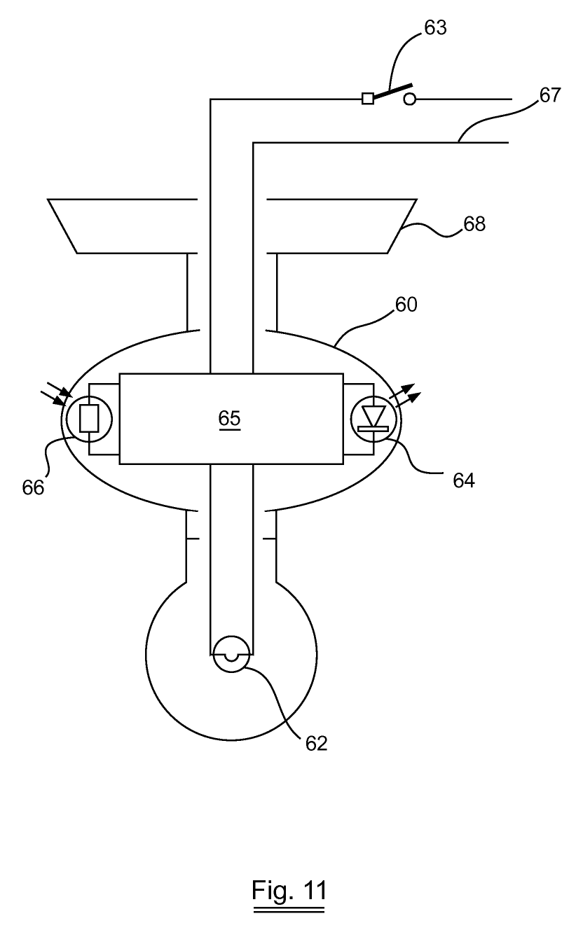

FIG. 11 shows how a lighting device according to the invention becomes, effectively, part of the existing electrical lighting circuit in the region (typically a room) in which it is used. The device, shown generally as 60, is positioned between an existing primary light source 62 (in this case a filament bulb) and the existing light switch 63, typically wall-mounted, which is used to control power to the primary light source. Operation of the switch 63 can then control both the LED(s) 64 of the device 60 and the primary light source 62, the controls 65 of the device (in conjunction with its light sensor 66) determining which of the two light sources is to be activated at any given time. The existing AC mains lighting circuit is shown generally at 67 and the existing light fitting (for example a ceiling-mounted pendant fitting) at 68.

1. A lighting device comprising (a) first connection means for connecting the device to an existing (“primary”) electrical light fitting, (b) second connection means for connecting the device to a primary light source, (c) an integrated secondary light source and (d) electrical and/or electronic controls arranged such that both the integrated secondary light source and a primary light source connected to the device via the second connection means can be operated using an existing primary switch associated with the primary light fitting.

2. A lighting device according to claim 1, wherein the first connection means comprises a male bayonet or screw connector.

3. A lighting device according to claim 1, wherein the second connection means comprises a socket adapted to receive a bayonet or screw type male connector.

4. A lighting device according to claim 1, wherein the second connection means has an annular screw threaded portion adapted to interengage with elements provided on a collar provided as part of the existing light fitting in order to attach a light shade to the fitting.

5. A lighting device according to claim 1, wherein the first connection means is for connecting the device to an existing wall- or ceiling-mounted light fitting.

6. A lighting device according to claim 5, wherein the existing light fitting is a ceiling-mounted pendant light fitting.

7. A lighting device according to claim 1, wherein the first connection means is for connecting the device to an existing lamp fitting.

8. A lighting device according to claim 1, wherein the integrated secondary light source is a light emitting diode (LED).

9. A lighting device according to claim 1, further comprising at least one other secondary light source.

10. A lighting device according to claim 9, wherein the secondary light sources are radially spaced around the periphery of the device.

11. A lighting device according to claim 1, wherein the secondary light source, the controls of the device and any associated user-operable controls are all housed within a single unit.

12. A lighting device according to claim 1, wherein the controls of the device are arranged to respond to one or more predetermined switching sequences at the primary switch.

13. A lighting device according to claim 1, wherein the controls of the device are arranged to allow the device to operate in two or more distinct modes, and for a user to select the desired mode via the primary light switch.

14. A lighting device according to claim 1, further comprising a light sensor capable of detecting the ambient light level and of signaling accordingly to the controls of the device.

15. A lighting device according to claim 14, wherein signals from the light sensor may be used to influence whether and/or when either or both of the primary and secondary light sources is on.

16. A lighting device according to claim 14, wherein the light sensor has a variable sensitivity.

17. A lighting device according to claim 1, further comprising means for varying the power output of the secondary light source.

18. A lighting assembly comprising a lighting device, and a primary light fitting, wherein the lighting device has (a) first connection means for connecting the device to the primary electrical light fitting, (b) second connection means for connecting the device to a primary light source, (c) an integrated secondary light source and (d) electrical and/or electronic controls arranged such that both the integrated secondary light source and a primary light source connected to the device via the second connection means can be operated using an existing primary switch associated with the primary light fitting.

19. A lighting device according to claim 1, in combination with a primary light source such as a bulb.

20. A method of providing illumination in a region which is provided with an existing primary light fitting and an associated primary switch, the method involving installing in the region a lighting device in electrical communication with both the primary light fitting and the primary switch, such that both the lighting device and the primary light fitting are controllable using the primary switch, wherein the lighting device has (a) first connection means for connecting the device to the primary electrical light fitting, (b) second connection means for connecting the device to a primary light source, (c) an integrated secondary light source and (d) electrical and/or electronic controls arranged such that both the integrated secondary light source and a primary light source connected to the device via the second connection means can be operated using an existing primary switch associated with the primary light fitting.

21. A method according to claim 20, wherein the lighting device is installed as part of an electrical circuit which connects the device, the primary light fitting and the primary switch, and wherein the circuit and the device are such that when the ambient light in the region is below a threshold level which can be selected on the lighting device, activation of the primary switch causes the integrated secondary light source of the device to illuminate, whereas if the ambient light is above said threshold, activation of the primary switch causes illumination of a primary light source connected to the primary light fitting via the lighting device.

22. A method according to claim 20, which is used to adapt the lighting already provided in the region.

23. A method according to claim 20 which additionally involves the step of selecting a desired threshold ambient light level on the controls of the lighting device.

24. A method according to claim 20 wherein the primary switch is a wall-mounted switch useable to operate an existing mains-wired wall- or ceiling-mounted light fitting.

25. An electrical lighting circuit comprising a primary light fitting, a primary light switch and a lighting device connected together in such a way that both the lighting device and the primary light fitting are controllable using the primary switch, wherein the lighting device has (a) first connection means for connecting the device to the primary electrical light fitting, (b) second connection means for connecting the device to a primary light source, (c) an integrated secondary light source and (d) electrical and/or electronic controls arranged such that both the integrated secondary light source and a primary light source connected to the device via the second connection means can be operated using an existing primary switch associated with the primary light fitting, and further such that when the ambient light in the region is below a threshold level which can be selected on the lighting device, activation of the primary switch causes the integrated secondary light source of the device to illuminate, whereas if the ambient light is above said threshold, activation of the primary switch causes illumination of a primary light source connected to the primary light fitting via the lighting device.

26. An electrical lighting circuit according to claim 25, wherein the primary light switch is a wall-mounted switch useable to operate an existing mains-wired wall- or ceiling-mounted light fitting.

27. A method of illuminating a region which is provided with an electrical lighting circuit comprising a primary light fitting, a primary light switch and a lighting device connected together in such a way that both the lighting device and the primary light fitting are controllable using the primary switch wherein the lightning device has (a) first connection means for connecting the device to the primary electrical light fitting, (b) second connection means for connecting the device to a primary light source, (c) an integrated secondary light source and (d) electrical and/or electronic controls arranged such that both the integrated secondary light source and a primary light source connected to the device via the second connection means can be operated using an existing primary switch associated with the primary light fitting, the method involving entering or approaching the region at a time when the ambient light is below a threshold level which has been selected on the lighting device, switching on the primary light switch, and thereby causing the secondary light source of the device to illuminate instead of a primary light source to which the device is connected.

28. A method according to claim 27, which is used to illuminate the region without causing disturbance to, or with reduced disturbance to, an occupant of the region.

29. A method of illuminating a region which is provided with an electrical lighting circuit comprising a primary light fitting, a primary light switch and a lighting device connected together in such a way that both the lighting device and the primary light fitting are controllable using the primary switch, wherein the lighting device has (a) first connection means for connecting the device to the primary electrical light fitting, (b) second connection means for connecting the device to a primary light source, (c) an integrated secondary light source and (d) electrical and/or electronic controls arranged such that both the integrated secondary light source and a primary light source connected to the device via the second connection means can be operated using an existing primary switch associated with the primary light fitting, the method involving entering or approaching the region at a time when the ambient light is above a threshold level which has been selected on the lighting device, switching on the primary light switch, and thereby causing activation of a primary light source connected to the lighting device instead of the secondary light source of the device.

30. A method for illuminating a region which involves entering or approaching the region, and utilising an existing primary light switch to control both an existing, primary light source and a device capable of providing illumination from an integrated secondary light source, so as to achieve a type and/or level of illumination, from either or both of the primary and secondary sources, which depends on the level of ambient light in the region.

31. A lighting device according to claim 15, wherein the light sensor has a variable sensitivity.

32. A lighting device according to claim 18 in combination with a primary light source such as a bulb.
